(19) United States
(12) Patent Application Publication
(10) Pub. No.: US 2011/0170538 A1
(43) Pub. Date: Jul. 14, 2011

(54) Method and System for Communications Roaming

(75) Inventor: Hui Liu, Beijing (CN)

(73) Assignee: BEIJING Z&W TECHNOLOGY CONSULTING CO., LTD., BEIJING CITY (CN)

(21) Appl. No.: 12/810,019

(22) PCT Filed: Aug. 25, 2009
(86) PCT No.: PCT/CN09/73481

§ 371 Date: Jun. 21, 2010

(30) Foreign Application Priority Data
Aug. 4, 2009 (CN) 200910090264.X

(51) Int. Cl. H04W 4/26; H04L 12/66

(52) U.S. Cl. 370/352; 455/432.1; 455/405

(57) ABSTRACT

A method and system for communications roaming discloses that end subscribers apply for numbers provided by roaming networks, connect their numbers in local networks to roaming network ones and then store them in the database in Global Roaming Interface Agent (GRIA). When a called number is dialed, the calling communications network first determines if the calling number or the called number belongs to a number in local network. If no, the calling network sends Global Roaming Interface Agent a request to search and check if the number in roaming network is stored under the calling number or the called number; if yes, the corresponding calling number or called number in roaming network will be used as the number for communication. Taking the technical solution from this invention, a flexible and low-cost global roaming communications system can be achieved by binding subscribers' multiple numbers to establish a uniform end-subscriber communications interface.

### BACKGROUND OF THE INVENTION

1. Technical Field

The present invention relates to communications technology field, and more particularly relates to a method and system for communications roaming.

2. Description of Related Art

With the fast development of globalization, to communicate in real time at a global scale is becoming more demanded. Cell phones (also computers, PSTN terminals, etc), as the ones of the important carriers of this type of communications needs are required to be connected to use in different regions depending on the homogeneous networks or even heterogeneous ones (such as GSM, CDMA, etc) offered by different communications operators, i.e. to achieve global roaming; on the other hand, it is not easy to reach global seamless roaming, mainly because:

1. The frequencies and telecommunication systems of different (countries') telecom networks are incompatible. Each country chooses preferred telecom networks mode on its own, for example, GSM or CDMA. However, GSM network and CDMA network are incompatible, i.e., the cell phones supporting GSM can hardly be used in the countries with CDMA network installed. In addition, due to the frequency control in different countries, network frequencies are generally different even if with the same kind of telecommunication networks. For example, some GSM operators in South America use 1900 Mhz frequency; in China, however, most cell phones support frequencies from 900 Mhz to 1800 Mhz. PSA system (similar to China's PHS system) is primarily deployed in Japan, although Japan now starts using WCDMA (a type of 3G network system), it is unable to down-compatible with GSM system. To solve this problem, subscribers sometimes have to buy multiple cell phones to make it work in different telecom network systems and frequencies in different regions; there are already dual-mode cell phones available to meet this requirement, which can simultaneously support two modes network (GSM and CDMA) on one cell phone.

2. The network access permissions among different telecom networks are not universally usable, since different countries guarantee different telecom service providers permissions to their telecom networks. These permissions generally are not valid from one region to another.

3. Billing issue. Different mobile operator will take different billing system. And their currently isolated billing systems make it fairly hard to charge telecom fees across isolated telecom networks.

4. Establish uniform subscriber communications interfaces. “Interface” is a commonly used concept in computer-associated systems design projects. The two sides of an interface work independently and communicate only by predefined protocols. Easily to maintain on the changes of both sides of interface is the biggest advantage of this design. Interface here indicates the two parties of the interface can connect to each other through the interface without knowing how the other party is connected to the interface. For example, subscriber A can be contacted by subscriber B in a real-time without necessarily notifying subscriber B its specific site, telecom operator's connection details, and if it has switched the specific site; on the contrary, subscriber A can contact subscriber B without knowing its site and service network that subscriber B is in. In actual global roaming operation, a calling subscriber does not need to know a called site and its network operator's information, and communicate with the called through the uniform access number.

Current global roaming issue is primarily settled by the roaming agreements signed by different telecom operators, allowing their own subscribers to enter each other's networks. Furthermore, different telecom operators sign MOU (Memorandum of Understanding), allowing local network subscribers' cell phone numbers to roam in other operators' networks, and then share fees based on predefined rules. And lastly, a locally registered telecom network number can be used as the uniform communications interface, i.e. subscribers use sole number to make or receive phone calls in roaming networks.

The current solution although can settle global roaming issue, there are following limitations existing:

1. High communications fees. For billing, extra-city roaming numbers are most local ones under current operating mode, meaning callings normally have to pay international long distance fees, which are fairly expensive. In extra-city networks, the subscribers even if in the same roaming network with callings also normally need to roam back the local networks and then roam to extra-city roaming networks to communicate, generating high fees.

2. Phone number consistency issue. When entering some countries' (Japan for example) telecom networks, subscribers normally need to subscribe local terminals and numbers to locally gain international roaming services. When leaving the countries, however, it is hard for the subscribers to keep their previous extra-city numbers (i.e., the numbers subscribed in other countries (Japan for example)), making it difficult to maintain customer relationships.

3. Service flexibility in non-local networks. In a real situation, it is fairly hard to connect the settlement systems from heterogeneous telecom networks in different cities. It is a common practice to sign roaming service fee collection agreement (i.e. MOU), one parity conducts uniform settlement (the other party normally generates service fee records simultaneously for easy verification afterwards), and then they share profits by pre-defined rules. There is an issue in this operating pattern—settlement inflexibility, i.e. service types that subscribers own in extra-cities are likely limited to roaming agreements, making it hard for them to communicate as they wish, or subscribers could not pick the services as they need from the service types provided by extra-city networks (please note, service items provided by extra-city networks could be updated, which can hardly be covered in originally singed roaming agreements). For example, after a subscriber roams from operator A's network I to operator B's network II, the services the subscriber owns in network II will be strictly confined to the roaming agreement signed by A and B. Thereby when B's services are updated (for example, data service is scaled up from GPRS to 3G, since the roaming agreement only covers GPRS-associated data service, however), the subscriber can hardly take such advantages.

### SUMMARY OF THE INVENTION

This invention presents a method and system for communications roaming to achieve flexible and low-costs international communications roaming services via multiple local network (virtual) numbers' binding to establish end subscribers' uniform communications interfaces.

For this purpose, the following technology solution is taken:

A method for communications roaming, comprising the following steps:

A. End subscribers apply for numbers provided by roaming networks and connect their numbers in local networks to roaming network ones and then store them in the database in Global Roaming Interface Agent;

B. When a calling number is dialed, the calling communications network first determines if the calling number or the called number belongs to the number in local network;

C. If no, the calling network sends Global Roaming Interface Agent a request to search to see if the number in roaming network is stored in the calling number or the called number;

D. If yes, then the calling number or called number in roaming network will be used as the communications number for communication. It also comprises following procedure:

End subscribers bind their numbers in local networks and roaming network ones with financial card's billing accounts while applying for roaming service, and store them in the Global Roaming Accounting System;

When the calling communications network determines that a calling number or a called number does not belong to the number in local network, it sends the Global Roaming Accounting System a request;

The Global Roaming Accounting System connects to financial card accounting system and checks if the financial card bound to the calling number or called one is valid;

If it is, the Global Roaming Accounting System sends the local network and roaming network to which the calling number or called one belongs a successful message.

It further comprises:

When a calling number and a called one are connected, the local network, roaming network, and Global Roaming Accounting System to which the numbers belong start generating a phone call record;

When the phone call ends, the local network, roaming network, and Global Roaming Accounting System to which the numbers belong stop the phone call record generating.

When a calling number is a number in local network while a called one is a number in roaming network;

The calling communications network sends a request to Global Roaming Interface Agent for it to return the local network area to which the calling and called numbers belong, the roaming network area to which the called number belongs, and the number in roaming network that is being used by the called number;

The calling communications network determines if the roaming network area to which the called number belongs is consistent with the local network area to which the calling number belongs; if yes, the calling number connects to the network number in which the called number is roaming;

If no, calling number's local network and called number's roaming network connect with their own VoIP gateway respectively, and the calling number connects to the network number in which the called number is roaming.

When a calling number is a number in roaming network while a called number is a number in roaming network;

Calling communications network sends a request to Global Roaming Interface Agent for it to return the local network areas to which the calling and called numbers belong respectively, the roaming network areas to which the calling number and the called number belong respectively, and the number in roaming networks that are being used by the calling number and the called number respectively;

The calling communications network determines if the roaming network area to which the called number belongs is consistent with the roaming network area to which the calling number belongs; if yes, the calling number in roaming network connects the called number in roaming network;

If no, calling number's roaming network and called number's roaming network connect with their own VoIP gateway respectively, and the calling number in roaming network connects the called number in roaming network.

When a calling number is a number in roaming network while a called number is a number in local network;

Calling communications network sends a request to Global Roaming Interface Agent for it to return the local network areas to which the calling number and the called number belong respectively, the roaming network areas to which the calling number and the called number belong respectively, and network numbers in which the calling number and called number are roaming respectively;

The calling communications network determines if the roaming network area to which the called number belongs is consistent with the roaming network area to which the calling number belongs; if yes, the calling number in roaming network connects the called number in roaming network;

If no, calling number's roaming network and called number's local network connect with their own VoIP gateway respectively, and the calling number in roaming network connects the called number in roaming network.

The step D further comprises:

the calling communications network returns the calling number the message of an invalid number or connection failed, if there is no network number is stored for the calling number or the called number in roaming.

In Step A the Global Roaming Interface Agent can provide end subscribers with interface to configure through the Internet.

A communications roaming system comprises no less than two communications networks, a calling terminal, a called terminal, and transmission network. The feature is that it also comprises a Global Roaming Interface Agent, a Global Roaming Accounting System, and a financial card accounting system, among which:

The calling terminal and the called terminal communicate through communications network;

Communications networks communicate through transmission network;

The Global Roaming Interface Agent connects no less than two communications networks to co-update real time status of number in roaming networks with them, and provide subscribers with configuration interface through the Internet. And The Global Roaming Interface Agent further comprises a database used to store the number in local networks and roaming network ones associated with subscribers;

The Global Roaming Accounting System and the financial card accounting system connect each other to check the validity of subscribers' financial cards;

The Global Roaming Accounting System further comprises a database used to store subscribers' number in local networks or financial card accounts bound to number in roaming networks; The Global Roaming Accounting System connects no less than two communications networks' telecom fee settlement systems and voice gateways, conducts account settlement through financial card accounts associated with subscribers, and simultaneously generates phone call records or network service time and billing records for telecom billing systems of associated communications network.

The mentioned transmission network is the Internet and the communications network connected to the described transmission network further comprises VoIP gateway; and the described transmission network could be PSTN network.

Taking the technical solution from this invention, it can not only establish uniform subscriber communications interfaces via subscribers' multiple local networks (virtual) numbers' binding to achieve flexible and low-costs international communications roaming services, but also solve heterogeneous communications network billing issue in extra-cities via subscribers' multiple accounts binding.

### BRIEF DESCRIPTION OF THE SEVERAL VIEWS OF THE DRAWINGS

FIG. 1 shows the communications roaming system structure chart for embodiments of this invention.

FIG. 2 shows the communications roaming flow chart for part embodiments of this invention.

FIG. 3 shows the communications roaming flow chart for part embodiments of this invention.

FIG. 4 shows the communications roaming flow chart for part embodiments of this invention.

FIG. 5 shows the communications roaming flow chart for part embodiments of this invention.

### DETAILED DESCRIPTION OF THE INVENTION

The technical solution of this invention can be further illustrated with attached figures and specific implementation methods.

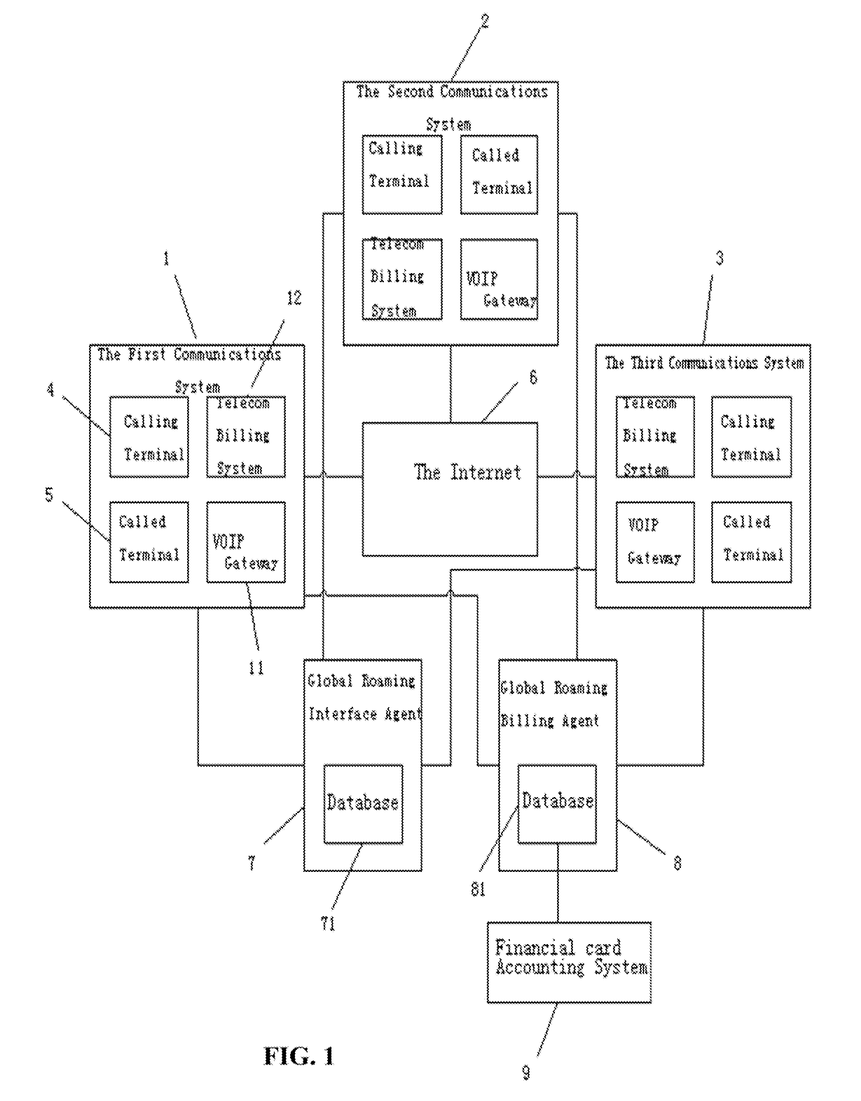

FIG. 1 is the communications roaming system structure chart for embodiments of this invention. As showed in FIG. 1, this communications roaming system comprises the first communications network 1, the second communications network 2, the third communications network 3, calling terminal 4, called terminal 5, transmission network 6, Global Roaming Interface Agent 7, Global Roaming Accounting System 8, and Financial card accounting System 9, among which, the transmission network is the Internet, the communications network connected with the Internet further comprises VoIP gateway 11, and the transmission network can also be PSTN. The calling terminal and called terminal is a type of terminal compatible with local communications network or roaming communications network (such as GSM, CDMA, 3G), and the local communications network or the roaming communications network could be any type of telecom network (such as GSM, WCDMA, and CDMA, etc).

The calling terminal and the called terminal communicate through communications network; and communications networks communicate through transmission network.

The Global Roaming Interface Agent connects to the first communications network, the second, and the third respectively to simultaneously update real-time status of number in roaming networks with them, and provides subscribers with configuration interface via the Internet. The Global Roaming Interface Agent further comprises Database 71, used to store associated subscribers' number in local networks and number in roaming networks.

The Global Roaming Accounting System connects to with financial card accounting system to check the validity of subscribers' financial cards such as banking cards and credit cards. And the Global Roaming Accounting System further comprises Database 81, used to store the financial card accounts bound to subscribers' number in local networks or number in roaming networks.

The Global Roaming Accounting System connects with the telecom billing systems 12 and voice gateways of the first, second, and third communications networks, conducts account billing tasks via the financial card accounts associated with subscribers, and simultaneously generates phone call records or network service time and billing records for telecom billing systems of associated communications networks.

End subscribers apply for number in roaming networks and associate their local numbers with the applied number in roaming networks and then store them in the database in the Global Roaming Interface Agent. These numbers can be either real communications network numbers or virtual numbers.

Table 1 and 2 represent a set of typical relationships (including the basic records required to achieve subscribers' needs only, additional tables can be added upon subscribers' service needs or additional records can be added in the existing tables in real systems) between local numbers and number in roaming networks stored in the database in the Global Roaming Interface Agent.

In Table 1, “User ID” stands for the sole identifier for registered subscribers, “Name” for subscribers' name, “CM”, “CT”, “VerM”, and “KDM”, etc are all telecom operators' network ID.

In Table 2, “Number” stands for the sole number a subscriber registered in that telecom operator, “Status” for corresponding number's status in that telecom network, indicating if the number is in that network, the status will be periodically (a 3-second period) updated by operator's network, yet operator's network can get subscriber number's real-time status.

TABLE 1

| User ID | Name | CM | CT | VerM | KDM | . . . |
|---|---|---|---|---|---|---|
| . . . | | | | | | . . . |
| CN03001 | Subscriber A | 1391001000 | N/a | 4081111000 | | . . . |
| . . . | . . . | . . . | . . . | . . . | . . . | . . . |
| CN05009 | Subscriber B | N/a | 1331003000 | 4092221111 | 5634441000 | . . . |

TABLE 2

| Number | Status | . . . |
|---|---|---|
| . . . | | . . . |
| 1391001000 | In this network | . . . |
| . . . | . . . | . . . |
| 1391122332 | Not in this network | . . . |

End subscribers bind their numbers in local networks and roaming network ones to financial cards' accounts while applying for roaming service and store them in the Global Roaming Accounting System.

Table 3 is a typical relationship list of financial card accounts associated with local and roaming numbers in different locations stored in the relational database in GRAS (relationship is established via user ID, there is just one financial card (credit card for example) for the subscriber, multiple financial cards can be associated with in real systems).

TABLE 3

| | | Credit Card | | |
|---|---|---|---|---|
| User ID | Name | Company ID | Credit Card Number | . . . |
| . . . | | | | . . . |
| CN03001 | Subscriber A | VISA | 96655 373773 29282 | . . . |
| . . . | . . . | | . . . | . . . |
| CN05009 | Subscriber B | Master Card | 78772 282877 28282 | . . . |
| . . . | . . . | . . . | . . . | . . . |

In implementation, communications roaming process can be classified into three scenarios: first one, the calling number is a number in local network, the called number is a number in roaming network; second one, the calling number is a number in roaming network, the called number is also a number in roaming network; and the third one, the calling number is a number in roaming network, the called number is a number in local network.

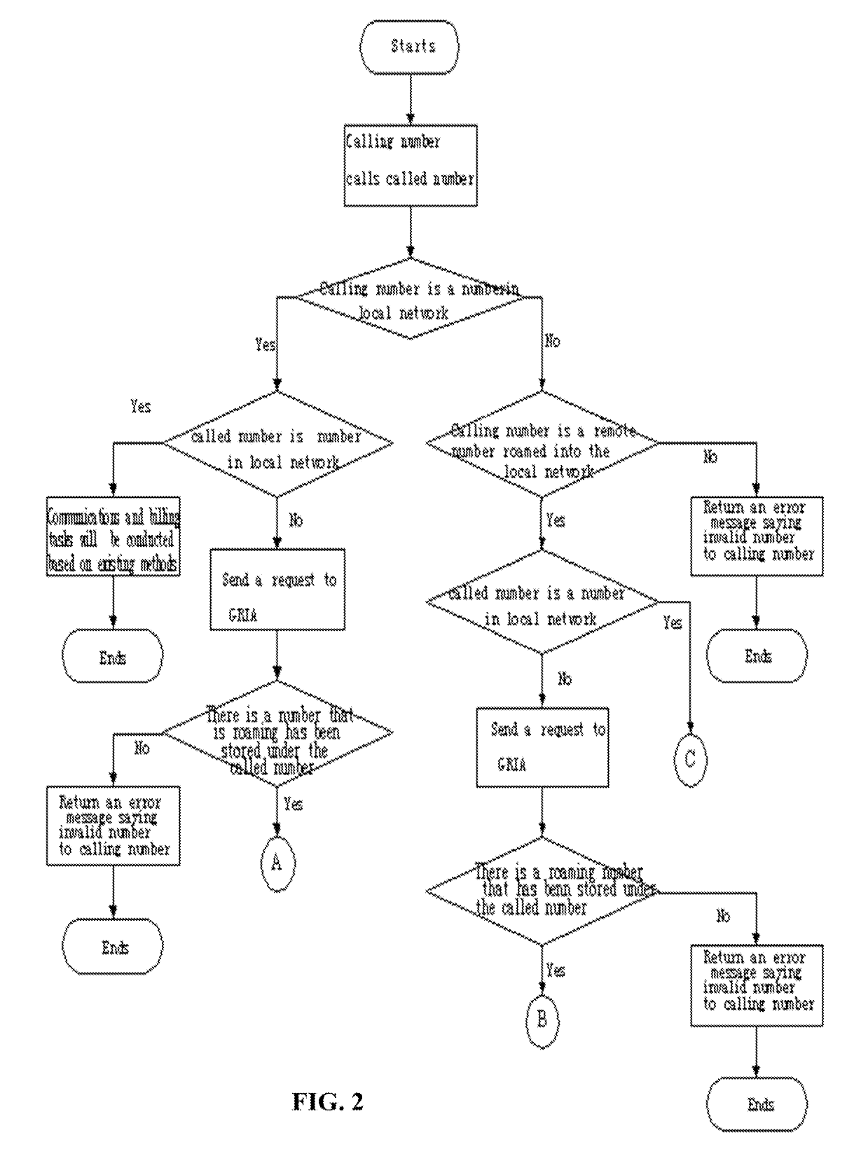

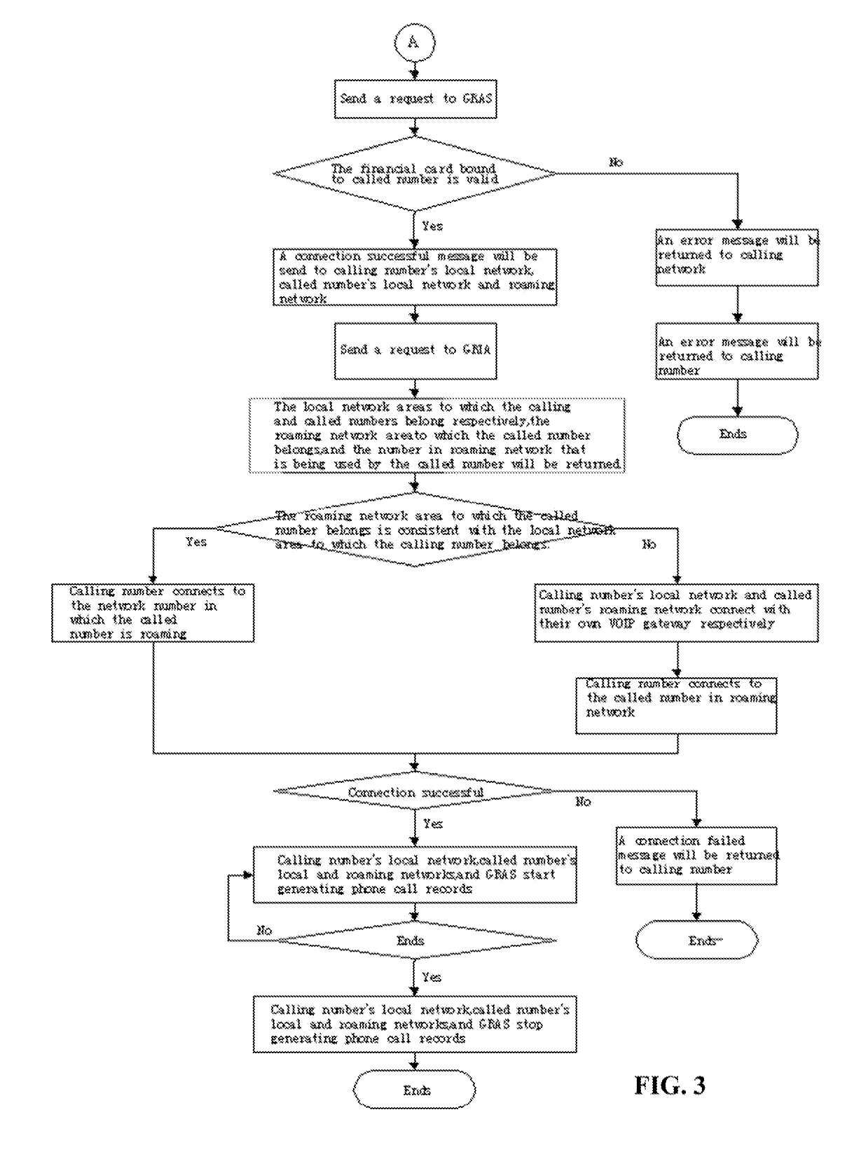

As showed in FIGS. 2 and 3, the communications roaming process comprises following procedure in the first scenario:

When a called number is dialed, the calling network determines if the calling number belongs to the number in local network.

If yes, then determines if the called number belongs to the number in local network.

If yes, then phone call communications and corresponding service charge will be conducted as an existing pattern.

If the called number does not belong to number in local network, the calling network sends GRIA a request to check if the called number has stored a number in the network that it is roaming in.

A number in the network that a subscriber is roaming in refers to the number in roaming network that the subscriber applied for in the communications network in the geographical position where the subscriber is physically located at.

If there is no stored number in the network that a subscriber is roaming in, then calling network returns calling number a connection failed message saying the called number is invalid.

If there is a stored number in the network that a subscriber is roaming in, then calling network send a request to GRAS connecting to financial card accounting system, and GRAS checks if the financial card bound to called number is valid.

If invalid, GRAS returns an error message to the calling network and a connection failed message to the calling number at the same time.

If valid, GRAS returns a “connection succeeded” message to calling number's local network, and the same message also goes to called number' local and roaming networks where the called number is roaming.

The calling communications network sends a request to Global Roaming Interface Agent for it to return the local network areas to which the calling and called numbers belong respectively, the roaming network area to which the called number belongs, and the number in roaming network that is being used by the called number, the calling communications network determines if the roaming network area to which the called number belongs is consistent with the local network area to which the calling number belongs.

For example, when Subscriber A is in Area 2, Subscriber B in Area 1 calls Subscriber A's number in local network 139-100-1000 in Area 1 to talk to Subscriber A, and Subscriber A and B are not in same area; or Area 2's local network subscriber C talks to Subscriber A by calling Subscriber A's number in local network 408-111-1000 in Area 2, and now Subscriber A and C are in same area.

If yes, the calling number connects to the network number in which the called number is roaming.

If no, calling number's local network and called number's roaming network connect with their own VoIP gateway respectively, and the calling number connects to the network number in which the called number is roaming.

When the connection between calling number and called number is established, calling number's local network, called number's local network, roaming network, and GRAS generate phone call records. If connection failed, then an error message saying connection failed will be sent to the calling number.

When the connection ends, calling number's local network, called number's local network, roaming network, and GRAS stop phone call record generating.

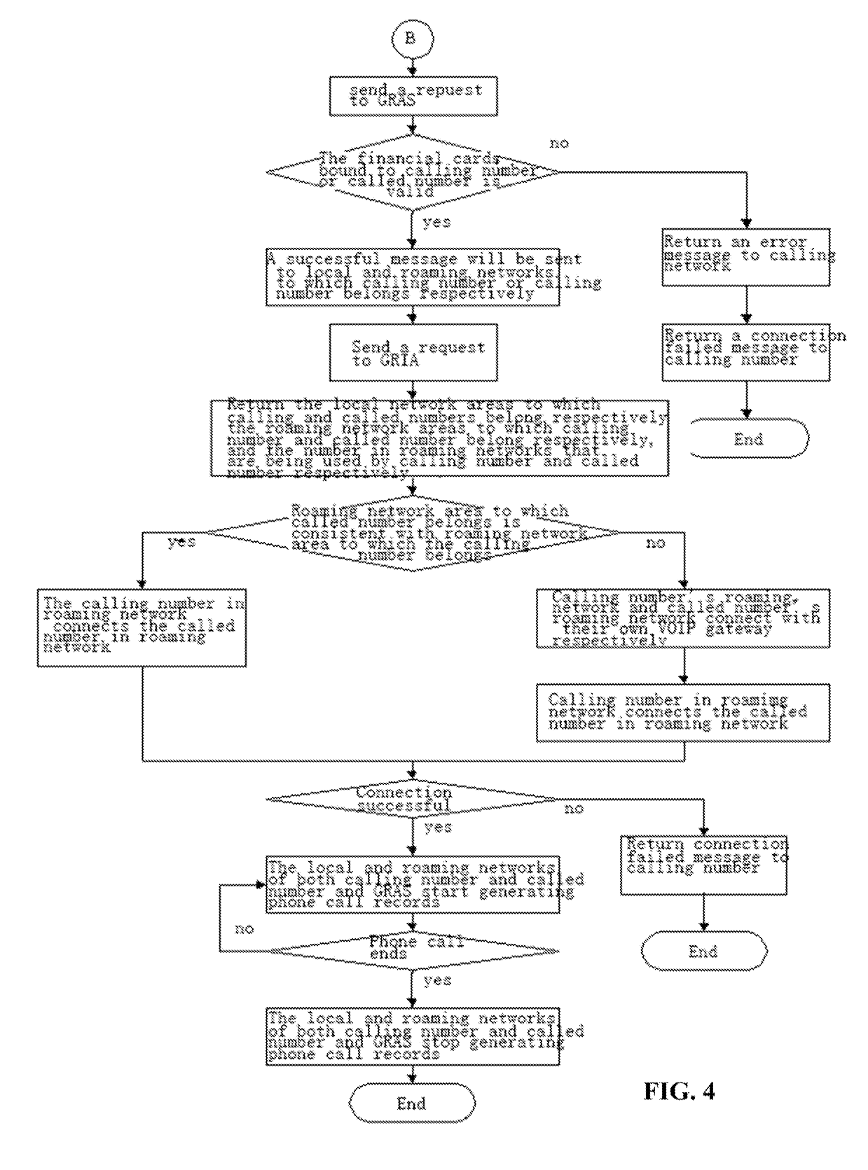

As showed in FIGS. 2 and 4, the communications roaming process comprises following procedure in the second scenario:

If calling network determines that the calling number is not a local network's calling number, and then determines if the calling number is the one roamed into local network from other city.

If no, the calling network returns the calling number an error message saying an invalid number.

If yes, the calling network then determines if the called number is a number in local network.

If no, the calling network sends Global Roaming Interface Agent a request to search and check if the number in roaming network is stored under the called number.

If no, calling network returns the calling number an error message saying an invalid number.

If yes, the calling network sends a request to GRAS connecting with financial card accounting system, and GRAS verifies the validity of the financial cards bound to the calling number or called number.

If invalid, GRAS returns both the calling network and calling number an error message.

If valid, GRAS returns a connection successful message to both the local network and roaming network to which the calling number or called number belongs.

The calling communications network sends a request to Global Roaming Interface Agent for it to return the local network areas to which the calling and called numbers belong respectively, the roaming network areas to which the called number and called number belong respectively, and the number in roaming networks that are being used by the called number and called number; the calling communications network determines if the roaming network area to which the called number belongs is consistent with the roaming network area to which the calling number belongs.

For example, when Subscriber A is in Area 1 and talks to Subscriber B by calling Subscriber B's number in local network 563-444-1000 in Area 3, and now Subscriber A and B are not in same area; or by calling Subscriber B's number in local network 408-111-1000 in Area 2, Subscriber A and B are not in same area.

If consistent, the connection between the calling number in roaming network and the called number in roaming network will be established.

If inconsistent, calling number's roaming network and called number's roaming network connect with their own VoIP gateway respectively, and the calling number in roaming network connects the called number in roaming network.

When a calling number and a called one are connected, the local network, roaming network, and Global Roaming Accounting System to which the numbers belong start a phone call record generating. If no connection established, a failed message will be returned to the calling number.

When the phone call ends, the local network, roaming network, and Global Roaming Accounting System to which the numbers belong stop the phone call record generating.

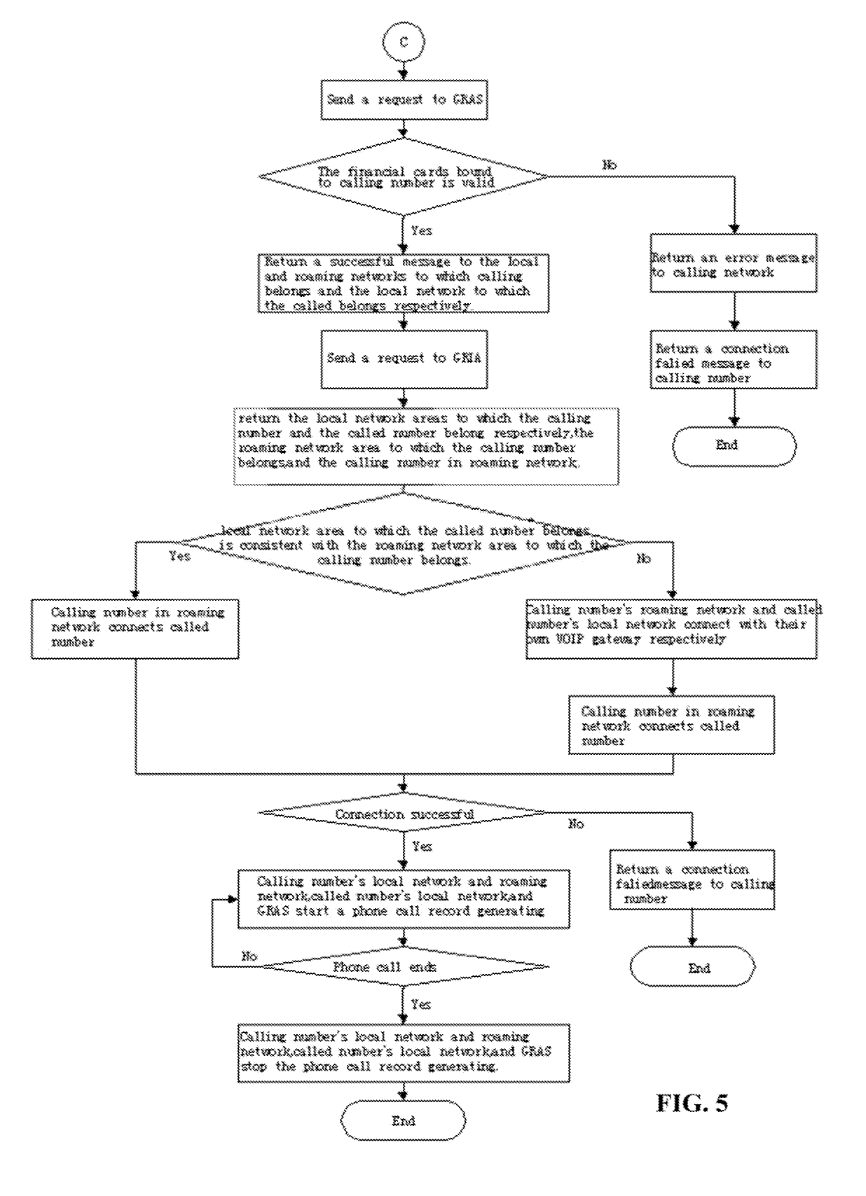

As showed in FIGS. 2 and 5, the communications roaming process comprises following procedure in the third scenario:

If the called number is determined to be number in local network, the calling network sends a request to GRAS connecting with financial card accounting system, and GRAS verifies the validity of the financial cards bound to the calling number.

If invalid, an error message will be returned to both the calling network and called number.

If valid, GRAS returns a connection success message to both the local network and roaming network to which the calling number belongs and the local network to which the called number belongs.

The calling communications network sends a request to Global Roaming Interface Agent for it to return the local network areas to which the calling and called numbers belong respectively, the roaming network area to which the calling number's roaming network belong and the number in roaming network being used by the calling number; the calling communications network determines if the local network area to which the called number belongs is same as the roaming network area to which the calling number belongs.

For example, when Subscriber A is in Area 2 and talks Subscriber B by calling Subscriber B's number in local network 133-100-3000 in Area 1, and now Subscriber A and B are not in same area; or talks Subscriber C's number in local network 405-222-5094 in Area 2, Subscriber A and C are now in same area.

If same, the connection between the calling number in roaming network and called number will be established.

If not same, calling number's roaming network and called number's local network connect with their own VoIP gateway respectively, and the calling number in roaming network connects called number.

When a calling number and a called one are connected, calling number's local network and roaming network, called number's local network, and Global Roaming Accounting System start a phone call record generating. If no connection established, a failed message will be returned to the calling number.

When the phone call ends, calling number's local network and roaming network, called number's local network and Global Roaming Accounting System stop the phone call record generating.

Any changes or replacements made by anyone familiar with this technology within the scope of the technology disclosed by this invention should be covered by the protection of this invention. This invention's protection scope is subject to the rights claimed by the inventor.

1. A method for communications roaming, the method comprising steps in which:
A. end subscribers apply for numbers provided by a roaming network and connect numbers of the end subscribers in local networks to the numbers of the roaming network and then store all in a database in a Global Roaming Interface Agent;
B. when a called number is dialed, a calling communications network for a caller first determines if a calling number of the caller or the called number belongs to the numbers in the local networks;
C. if no in Step B, the calling communications network sends the Global Roaming Interface Agent a request to search and check if the calling number or the called number is stored in the roaming network; and
D. if yes in Step C, the number connected to the calling number or the called number in the roaming network will be used as a communications number for communication.

2. The method of claim 1, further comprising steps in which:
the end subscribers bind the numbers thereof in the local networks and the numbers of the roaming network with financial card accounts while applying for roaming service, and store all in a Global Roaming Accounting System;
when the calling communications network determines that the calling number or the called number does not belong to the numbers in the local networks, the calling communications network sends the Global Roaming Accounting System a request;
the Global Roaming Accounting System connects to financial card accounting systems and checks if the financial card accounts bound to the calling or called number are valid; and
If yes, the Global Roaming Accounting System sends the local networks and roaming network to which the calling number or the called number belongs a successful message.

3. The method of claim 2, further comprising steps in which:
when the calling number and the called number are connected to start a phone call, the local networks, roaming network, and Global Roaming Accounting System to which the numbers belong start generating a phone call record; and
when the phone call ends, the local networks, roaming network, and Global Roaming Accounting System to which the numbers belong stop the phone call record generating.

4. The method of claim 1, wherein:
when the calling number is in the local networks, but the called number is in the roaming network, the calling communications network sends a request to the Global Roaming Interface Agent therefor to return local network areas to which the calling and called numbers belong, a roaming network area to which the called number belongs, and a number in the roaming network that is being used by the called number;
the calling communications network determines if the roaming network area to which the called number belongs is same as the local network area to which the calling number belongs;
if yes, the calling number connects to the number of the roaming network in which the called number is roaming; and
if no, calling number's local network and called number's roaming network establish connection by respective VoIP gateways thereof, and the calling number connects to the returned number of the roaming network in which the called number is roaming.

5. The method of claim 1, wherein:
when both the calling number and the called number are in the roaming network, the calling communications network sends a request to the Global Roaming Interface Agent therefor to return local network areas to which the calling and called numbers belong, roaming network areas to which the calling number and the called number belong, and the numbers in the roaming networks that are being used by the calling number and the called number respectively;
the calling communications network determines if a roaming network area to which the called number belongs is same as a roaming network area to which the calling number belongs;
if yes, the calling number in the roaming network thereof connects to the called number in the roaming network thereof; and
if no, calling number's roaming network and called number's roaming network establish connection by respective VoIP gateways thereof, and the returned number for the calling number in the roaming network thereof connects to the returned number for the called number in the roaming network thereof.

6. The method of claim 1, wherein:
when the calling number is in the roaming network, but the called number is in the local networks, the calling communications network sends a request to the Global Roaming Interface Agent therefor to return local network areas to which the calling number and the called number belong respectively, a roaming network area to which the calling number belongs, and the number for the calling number in the roaming network;
the calling communications network determines if a local network area to which the called number belongs is same as a roaming network area to which the calling number belongs;
if yes, the calling number in the roaming network connects the called number; and
if no, calling number's roaming network and called number's local network establish connection by respective VoIP gateways thereof, and the number for the calling number in the roaming network connects the called number.

7. The method of claim 1, wherein the step D further comprises a step in which:
the calling communications network returns the calling number a message of an invalid number or connection failed if no number from the roaming network is stored for the calling number or the called number.

8. The method of claim 1, wherein, in step A, the Global Roaming Interface Agent provides the end subscribers with interfaces to configure through the Internet.

9. A system for communications roaming, the system comprising no less than two communications networks, a calling terminal, a called terminal, and a transmission network, the system further comprising a Global Roaming Interface Agent, a Global Roaming Accounting System, and a financial card accounting system, wherein:
the calling terminal and the called terminal communicate through the no less than two communications networks;
the no less than two communications networks communicate through the transmission network;
the Global Roaming Interface Agent connects to the no less than two communications networks and synchronously updates real-time status of numbers in roaming networks with the no less than two communications networks, and provides subscribers with configuration interfaces through the Internet, the Global Roaming Interface Agent further comprises a database used to store numbers in local networks and the roaming networks associated with the subscribers;
the Global Roaming Accounting System and the financial card accounting system connect to each other to check validity of subscribers' financial cards;
the Global Roaming Accounting System further comprises a database used to store subscribers' numbers in the local networks or financial accounts bound to subscribers' numbers in the roaming networks; and
the Global Roaming Accounting System connects telecom billing systems and voice gateways of the no less than two communications networks, provides billing service through financial card accounts associated with the subscribers, and simultaneously generates phone call records or network service time and billing records for telecom billing systems of associated communications networks from the no less than two communications networks.

10. The system of claim 9, wherein the transmission network is the Internet, and the no less than two communications networks connected to the transmission network further comprise VoIP gateways; and the transmission network is a PSTN network.
